(19) United States
(12) Patent Application Publication
(10) Pub. No.: US 2019/0154885 A1
(43) Pub. Date: May 23, 2019

(54) PANORAMIC IMAGING SYSTEM

(71) Applicant: Robert Bosch Start-Up Platform North America, LLC, Series 1, Redwood City, CA (US)

(72) Inventors: Audrey Steever, Fremont, CA (US); Todd Louis Harris, Fremont, CA (US)

(21) Appl. No.: 16/192,877

(22) Filed: Nov. 16, 2018

Related U.S. Application Data
(60) Provisional application No. 62/625,240, filed on Feb. 1, 2018.
(60) Provisional application No. 62/625,205, filed on Feb. 1, 2018.
(60) Provisional application No. 62/588,244, filed on Nov. 17, 2017.

(51) Int. Cl. G02B 3/04; G02B 13/06

(52) U.S. Cl. CPC G02B 3/04; G02B 2003/0093; G02B 13/06

(57) ABSTRACT

A panoramic annular lens projects a spherical field of view onto a two-dimensional annular format. The panoramic annular lens includes a body, a first refractive surface configured to refract input light rays to obtain first refracted light rays, a first reflective surface configured to reflect the first refracted light rays to obtain first reflected light rays, a second reflective surface configured to reflect the first reflected light rays to obtain second reflected light rays, and a second refractive surface configured to refract the second reflected light rays to obtain output light rays in the two-dimensional annular format. The second refractive surface is externally concave.

### CROSS-REFERENCE TO RELATED APPLICATIONS

This application claims the benefit of U.S. provisional application No. 62/625,240 filed Feb. 1, 2018; U.S. provisional application No. 62/625,205 filed Feb. 1, 2018; and U.S. provisional application No. 62/588,244 filed Nov. 17, 2017, the disclosures of which are hereby incorporated in their entirety by reference herein.

### TECHNICAL FIELD

This invention relates generally to the optics field, and more specifically to a new and useful annular imaging system in the optics field.

### BACKGROUND

Optical systems can be used in range finding applications, navigation applications, radial metrology applications, laser-based applications, illumination, or other suitable operations.

### SUMMARY

In a first embodiment, a panoramic annular lens for projecting a spherical field of view onto a two-dimensional annular format is disclosed. The panoramic annular lens includes a body, a first refractive surface configured to refract input light rays to obtain first refracted light rays, a first reflective surface configured to reflect the first refracted light rays to obtain first reflected light rays, a second reflective surface configured to reflect the first reflected light rays to obtain second reflected light rays, and a second refractive surface configured to refract the second reflected light rays to obtain output light rays in the two-dimensional annular format. The second refractive surface is externally concave. The second refractive surface may have a curvature between 0.01 and 0.05. The second refractive surface may have a conic constant of 0. A radius of curvature of the second refractive surface may be a fourth of a radius of curvature of the second reflective surface. The second refractive surface may be aspheric. The first reflective surface may a curvature of −0.1 to −0.04. The first reflective surface may be internally concave.

In another embodiment, a panoramic annular lens for projecting a spherical field of view onto a two-dimensional annular format is disclosed. The panoramic annular lens includes a body, a first refractive surface configured to collect input light rays from a predetermined angular range (e.g., +35° to −28° measured from a plane intersecting the first refractive surface and to refract the input light rays to obtain first refracted light rays, a first reflective surface configured to reflect the first refracted light rays to obtain first reflected light rays, a second reflective surface configured to reflect the first reflected light rays to obtain second reflected light rays, and a second refractive surface configured to refract the second reflected light rays to obtain output light rays in the two-dimensional annular format. The first refractive surface may be externally convex. The predetermined angular range is +32° to −28°. The first refractive surface may be aspheric. The body and the surfaces may be formed of a single block of transmissive material. The transmissive material may be polycarbonate, polystyrene, or glass. The reflective surfaces may be coated with a reflective coating.

In yet another embodiment, an imaging system for recording images of an illuminated scene is disclosed. The imaging system includes a panoramic annular lens including a body, a first refractive surface configured to collect input light rays from the illuminated scene and to refract the input light rays to obtain first refracted light rays, a first reflective surface configured to reflect the first refracted light rays to obtain first reflected light rays, a second reflective surface configured to reflect the first reflected light rays to obtain second reflected light rays, a second refractive surface configured to refract the second reflected light rays to obtain output light rays, and an optical sensor offset the PAL axis and configured to collect the output light rays and to convert the output light rays into sensor signals or current. The first and second refractive surfaces and the first and second reflective surfaces are coaxially aligned with each other along a PAL axis.

In this embodiment, the optical sensor includes microlens arrays. The PAL may include chief ray angles matched to ray angles of the microlens arrays. The imaging system may further include an aperture stop configured to adjust a cone angle of diverging rays within the output light rays. The aperture stop may be situated between the PAL and the optical sensor. The imaging system may further include a filter configured to selectively transmit rays having predetermined optical properties within the output light rays. The filter may be situated between the aperture stop and the optical sensor. The predetermined optical properties may be wave length and polarity. The filter and the aperture stop may be coaxially aligned.

### BRIEF DESCRIPTION OF THE DRAWINGS

FIG. 1 is a schematic representation of an example optical system for use with an imaging system.

FIG. 2 is an isometric view of an example of the optical system.

FIG. 3 is a cutaway view of an example panoramic lens (PAL).

FIG. 4 is a plane view from the bottom of the example PAL.

FIG. 5 is a ray trace of light travelling through an example imaging system.

FIG. 6 is a ray trace of light travelling through a specific example of the PAL.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Imaging system 10 functions to record images of an illuminated scene 12. Imaging system 10 includes optical sensor 14 and lens 16, but can also include: a collector lens, an aperture stop, a filter, and/or any other suitable component.

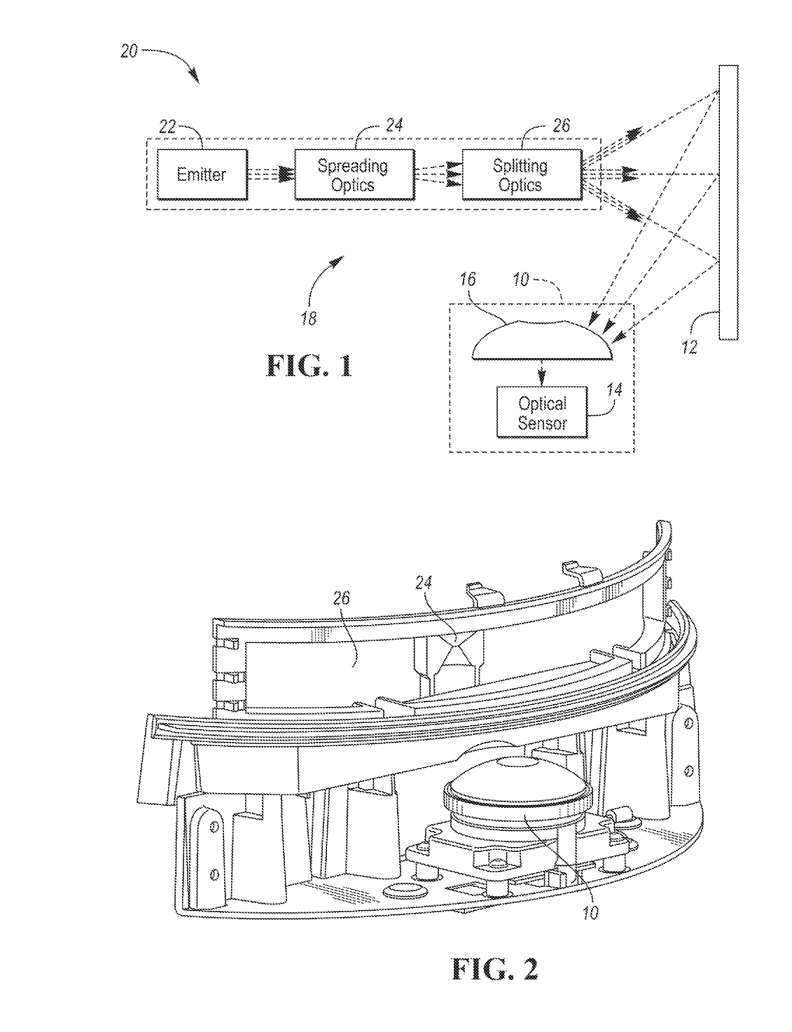

Imaging system 10 may be used in optical system 18 (examples shown in FIG. 1 and FIG. 2) that also illuminates scene 12 but can be used in any suitable application. Optical system 18 can include one or more imaging systems, wherein different imaging systems can be configured to capture different portions of an illuminated ambient scene. Each imaging system (e.g., including one or more lens or sensors) can be corrected within itself, and the entire group re-optimized as a unit. However, multiple imaging systems can be otherwise cooperatively used. The output of imaging system 10 can be used for: object detection, navigation, mapping, 3D reconstruction, or otherwise used. In one example, the output of imaging system 10 (e.g., the image, array of signal values, etc.) can be converted into a point cloud, wherein objects can be detected within the point cloud.

Imaging system 10 may be axially symmetric, but can be radially symmetric, asymmetric, or have any suitable symmetry. Imaging system 10 can be axially symmetric about a monitoring axis (e.g., the passthrough beam axis) or axially symmetric about an auxiliary axis. The auxiliary axis can extend perpendicular the passthrough beam axis, at any suitable angle to the passthrough beam axis, or be otherwise arranged.

A. Optical Sensor

Optical sensor 14 of imaging system 10 functions to capture an image created by lens 16 (e.g., convert light waves collected by lens 16 into sensor signals or current). Imaging system 10 can include one or more optical sensors. Optical sensor 14 can be connected to a processor (e.g., microprocessor, etc.) that controls optical sensor operation, a power source (e.g., a battery, such as a lithium chemistry battery, metal hydride battery, etc.), and other power electronics. Optical sensor 14 can be a CCD sensor, CMOS sensor, NMOS sensor, live MOS sensor, photodetector array, optical receiver, phase detector, or any other suitable sensor type. Optical sensor 14 can be a multispectral sensor, hyperspectral sensor, unispectral sensor (e.g., sensitive to an illumination beam's wavelength only), or be sensitive in any other suitable set of wavelengths. In a specific example, the optical sensor is sensitive to wavelengths between 800 nm to 900 nm, more preferably 850 nm but alternatively any other suitable set of wavelengths.

B. Lens

Lens 16 of imaging system 10 functions to project a field of view of a scene onto a 2-dimensional format. Imaging system 10 may include a single lens but can alternatively include a stack of lenses (e.g., the projected image is passed to a subsequent lens), a lens array, or include any suitable number of lenses of the same or different configuration arranged in any suitable arrangement.

Lens 16 may be a panoramic annular lens but can be any other suitable lens. The panoramic annular lens (PAL) functions to project a spherical field of view onto a two-dimensional annular format. The PAL can enlarge the system field of view (FOV), create an axially symmetric FOV (e.g., horizontally symmetric FOV), or confer any other suitable set of benefits.

The PAL may be axially symmetric, but can alternatively be axially asymmetric (e.g., horizontally, along an axis parallel the illumination axis). The PAL may be radially asymmetric but can alternatively be radially symmetric.

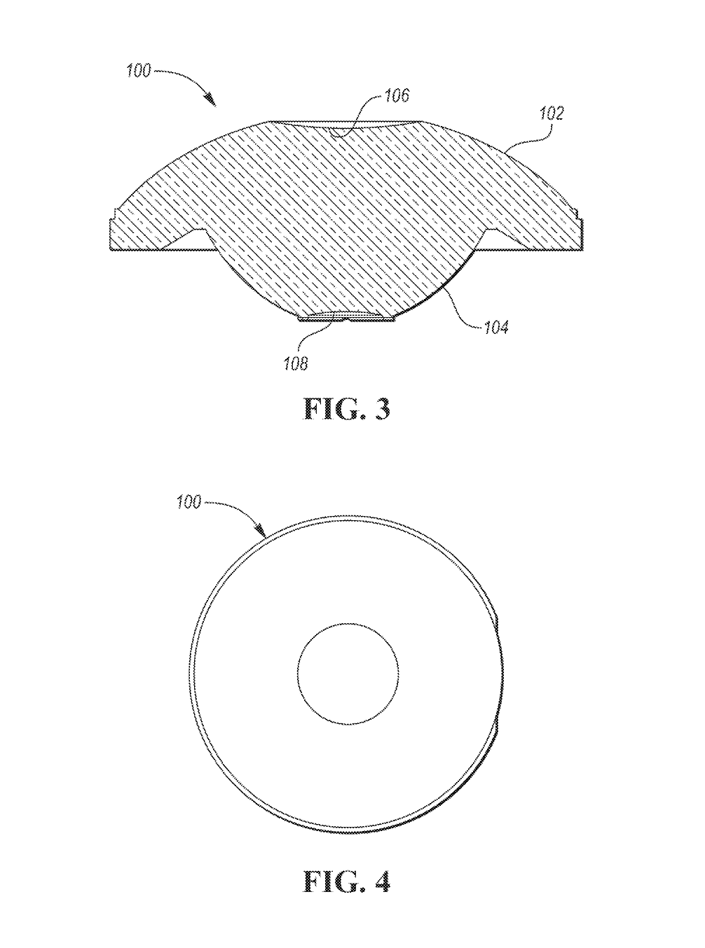

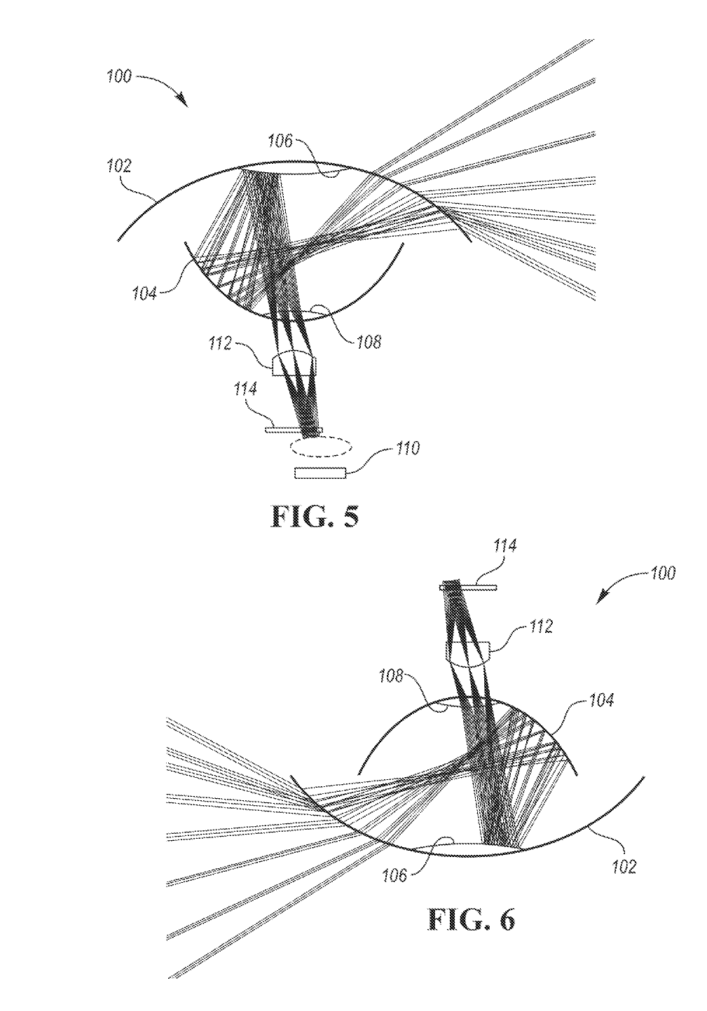

As shown in FIG. 3, PAL 100 includes two refractive surfaces 102 and 108, and two reflective surfaces 104 and 106. As shown in FIG. 5, in operation, a set of input light rays are incident upon and refracted by first refractive surface 102, are reflected by first reflective surface 104, are reflected by second reflective surface 106, and exit PAL 100 through second refractive surface 108 and travel toward optical sensor 110. The input light rays can be collected from a predetermined angular range (e.g., measured from a plane intersecting first refractive surface 102), a dynamically adjustable angular range (e.g., the curvature of first refractive surface 102 is adjustable), or from any suitable angular range. In the embodiment shown in FIG. 6, the angular range is +35° to −28° but can alternatively be +60° to −60°, +35° to −25°, +32° to −28°, or any other suitable range.

PAL 100 may be formed as a single block. For example, PAL 100 can be made of optical grade polycarbonate, polystyrene, glass, or any other suitable transmissive material. The material can be broadly transparent or transparent to only selected wavelengths. In this variation, the refractive surfaces can be the interfaces between the material of PAL 100 and the ambient environment, while the reflective surfaces can be formed into the block and coated with reflective coating. In one example, the reflective coating can be a material that reflects more than 95% of incident light at the illumination light's wavelength (e.g., between 800 nm to 900 nm, 840 nm to 869 nm, 850 nm, etc.), such as protected aluminum, enhanced aluminum, UV enhanced aluminum, DUV enhanced aluminum, bare gold, protected gold, and protected silver. However, any suitable reflective coating can be used.

Alternatively, PAL 100 can be formed from multiple layers (e.g., planar layers, curved layers, etc.), wherein the interface between adjacent layers can form the refractive and/or reflective surfaces (e.g., wherein the interfaces can be coated, the adjacent layers can have different refraction indices, etc.).

First refractive surface 102 functions to refract incoming light rays. First refractive surface 102 can be curved, and in certain embodiments, externally convex, but can be otherwise configured. First refractive surface 102 may be aspheric, but can alternatively be spheric, ellipsoidal, paraboidal, or otherwise structured. The conic constant of first refractive surface 102 may be between −0.05 and +2.0, or between −0.05 and −0.10, and more preferably −0.86, but can alternatively have any suitable conic constant. The curvature of first refractive surface 102 (first curvature) may be between 0.05 and 0.02, and in certain embodiments, 0.036, but can alternatively be any other suitable value. The radius of curvature of first refractive surface 102 may be approximately 2× the radius of curvature of first reflective surface 102, but can be otherwise related to other PAL surfaces, the illumination system dimensions (e.g., a splitter optic dimension, a spreading optic dimension, etc.), and/or any other suitable optical system component. In one example, the radius of curvature of first refractive surface 102 can be 31.3491 mm. In this example, the outer diameter of the first refractive surface can range from 44.03 mm toward the center to 45.40 mm at the edge. In this example, the vertex thickness can be between 15 mm to 20 mm, such as 18.186 mm, or be any suitable thickness. In one variation, first refractive surface 102 can include a step (e.g., chord) in the outer diameter, between first refractive surface 102 and first reflective surface 104. This step can enable PAL abutment to the housing (e.g., without introducing vignetting), or be otherwise used. In one example, the step can be 22 mm from the centerline of PAL 100, and have a height of 16.52 mm, or have any suitable set of dimensions. In one variation, second reflective surface 106 can be defined in the same side of the PAL as first refractive surface 102, such as the center of first refractive surface 102 (e.g., first refractive surface 102 and second reflective surface 106 are concentrically arranged). In this variation, first refractive surface 102 can include an inner diameter. In one example, the inner diameter can range from 15.37 mm toward the center to 20.0 mm toward the edge. However, first refractive surface 102 can have any other suitable radius of curvature or set of dimensions.

First reflective surface 104 functions to reflect light, refracted by first refractive surface 102, toward second reflective surface 106. First reflective surface 102 may be arranged opposing first refractive surface 102 across the body of PAL 100 but can be otherwise arranged. First reflective surface 104 may be coaxially aligned with first refractive surface 102 but can be offset or otherwise arranged. First reflective surface 104 may be the interior surface of the bottom of PAL 100 but can be otherwise defined. First reflective surface 104 may be curved, and in some embodiments, internally concave, but can be otherwise configured. First reflective surface 104 may be aspheric, but can alternatively be spheric, ellipsoidal, paraboidal, or otherwise structured. The exterior or interior of first reflective surface 104 may be coated with a reflective coating but can be otherwise treated. The conic constant of first reflective surface 104 may be 0 but can alternatively have any suitable conic constant. The curvature of first reflective surface 104 (second curvature) is preferably between −0.1 and −0.05, and in some embodiments −0.068, but can alternatively be any other suitable value. The radius of curvature of first reflective surface 104 may be approximately ½ the radius of curvature of first refractive surface 102 but can be otherwise related to the other PAL surfaces, a dimension of illumination system 20 (e.g., a dimension of splitter optic 26, a dimension of spreading optic 24, etc.), and/or any other suitable optical system component. In one example, the radius of curvature of first reflective surface 104 can be −14.608 mm. In this example, the outer diameter of first reflective surface 104 can range from 26.6 mm at the center to 27.48 mm at the edge. In this example, the height of first reflective surface 104 can be between 5 mm to 10 mm, such as 6.158 mm, or be any suitable height. In one variation, second refractive surface 108 can be defined in the same side of PAL 100 as first reflective surface 104, such as in the center of first reflective surface 104 (e.g., first reflective surface 104 and second reflective surface 106 are concentrically arranged). In this variation, first reflective surface 104 can include an inner diameter. In one example, the inner diameter can range from 9.76 mm toward the center to 11.6 mm toward the edge. However, first reflective surface 104 can have any other suitable radius of curvature or set of dimensions.

Second reflective surface 106 functions to reflect light, reflected by first reflected surface 104, toward second refractive surface 106. Second reflective surface 106 may be arranged opposing first refractive surface 102 across the body of PAL 100 but can be otherwise arranged. Second reflective surface 106 may be coaxially aligned with first reflective surface 104 but can be offset or otherwise arranged. Second reflective surface 106 may be the interior central surface of the top of PAL 100 (e.g., an externally concave portion of an upper section of PAL 100) but can be otherwise defined. Second reflective surface 106 may be curved, and in some embodiments, internally convex but can be flat or otherwise configured. Second reflective surface 106 may be aspheric, but can alternatively be spheric, ellipsoidal, paraboidal, or otherwise structured. The exterior or interior of second reflective surface 106 may be coated with a reflective coating but can be otherwise treated. The conic constant of second reflective surface 106 may be 0, but can alternatively have any suitable conic constant. The curvature of second reflective surface 106 (third curvature) may be between 0.05 and 0.1, and in certain embodiments −0.069655, but can alternatively be any other suitable value. The curvature of second reflective surface 106 may be substantially similar to the curvature of first reflective surface 104 but can be otherwise related to the other PAL surfaces, a dimension of illumination system 20 (e.g., a dimension of splitter optic 26, a dimension of spreading optic 24, etc.), and/or any other suitable optical system component. In one example, the radius of curvature of second reflective surface 106 can be −41.936 mm. In this example, the outer diameter of second reflective surface 106 can range from 13.4 mm toward the center to 15.13 mm toward the edge (e.g., be 33% of the diameter of first refractive surface 102). However, second reflective surface 106 can have any other suitable radius of curvature or set of dimensions.

Second refractive surface 108 functions to refract light, reflected by second reflective surface 106, out of PAL 100. Second refractive surface 108 may refract light at an angle (e.g., 45°, 30°) to the central axis of PAL and/or the central axis of second refractive surface 108 but can be otherwise configured. Second refractive surface 108 may be arranged opposing second reflective surface 106 across the body of PAL 100 but can be otherwise arranged. Second refractive surface 108 can be coaxially aligned with second reflective surface 106 but can be offset or otherwise arranged. Second refractive surface 108 may be the interior surface of the bottom of PAL 100 (e.g., an externally concave portion of the lower section of PAL 100) but can be otherwise defined. Second refractive surface 108 may be curved, and in some embodiments, internally convex, but can be otherwise configured. Second refractive surface 108 may be aspheric, but can alternatively be spheric, ellipsoidal, paraboidal, or otherwise structured. The exterior or interior of second refractive surface 108 may be coated with an anti-reflective coating but can be otherwise treated. The conic constant of second refractive surface 108 may be 0 but can alternatively have any suitable conic constant. The curvature of second refractive surface 108 (second curvature) may be between 0.01 and 0.05, and in certain embodiments, 0.0158, but can alternatively be any other suitable value. The radius of curvature of second refractive surface 108 may be approximately a fourth the radius of curvature of second reflective surface 106 but can be otherwise related to the other PAL surfaces, a dimension of illumination system 20 (e.g., a dimension of splitter optic 26, a dimension of spreading optic 24, etc.), and/or any other suitable optical system component. In one example, the radius of curvature of second refractive surface 108 can be 14.357 mm. In this example, the outer diameter of second refractive surface 108 can range from 6.2 mm at the center to 7.61 mm at the edge. However, second refractive surface 108 can have any other suitable radius of curvature or set of dimensions.

Imaging system 10 may include a collector lens, which functions to form real images of internal points refracted by first refractive surface 102 and converge the divergent rays leaving second refractive surface 108. Imaging system may include one or more collector lenses of the same or different type, arranged in an array, a stack, or in any other suitable configuration. The collector lens may be a biconvex lens but can be any other suitable lens. The collector lens may be located between PAL 100 and optical sensor 110, and in certain embodiments, between aperture 112 and filter 114 (e.g., aperture 112 is arranged between PAL 100 and filter 114) but can alternatively be arranged between PAL 100 and aperture 112, between filter 114 and optical sensor 110, or be arranged in any suitable location.

Imaging system 10 may include aperture stop 112, which functions to adjust the cone angle of the diverging rays refracted by second refractive surface 108. Aperture 112 may be small (e.g., 3 to 10 mm, 4.3 mm, etc.), but can alternatively be any suitable size. Aperture 112 may be arranged close to second refractive surface 108 (e.g., within 10 mm, 20 mm, etc.), but can be arranged at any suitable position relative to second refractive surface 108. Aperture 112 can be coaxially aligned with second refractive surface 108 but can be offset from second refractive surface 108 or otherwise arranged. Aperture 112 may be static, but can alternatively be adjustable (e.g., vary as a function of ambient light, application, etc.).

Imaging system 10 may include filter 114, which functions to selectively transmit rays having a predetermined set of optical properties (e.g., wavelength, polarity, etc.). Filter 114 is preferably arranged after aperture 112 but can be otherwise arranged. Filter 114 may be a wavelength filter and selects for the input beam's wavelength (e.g., to reduce signal noise), but can alternatively be any other suitable filter. The wavelength filter can be a band-pass filter matched to the emitted wavelength, be a low-pass filter, or be any other suitable filter. In a specific example, filter 114 selectively permits transmission of 840 to 860 nm wavelength light through. However, any other suitable set of filters can be used.

The chief ray angles of the lens are preferably well matched within 10% to any microlens arrays that are part of or installed over optical sensor 14 but can be otherwise arranged. The axis of PAL 100 can be centered on and perpendicular the microlens array but it can be offset, rotated, tilted, or be otherwise arranged. Image circle 116 can underfill, overfill, or only partially overlap optical sensor 14.

Optical system 18 may further include illumination system 20. Illumination system 20 may include emitter 22, spreading optics 24, and splitting optics 26. Illumination system functions to illuminate scene 12. Emitter 22 functions to emit electromagnetic waves, which are subsequently reshaped by spreading optic 24 and splitter optic 26. Spreading optic 24 functions to spread the electromagnetic waves emitted by emitter 22. Splitter optic 26 functions to divide an input beam into one or more beams, separated by one or more angles of separation (separation angles).

The following applications are related to the present application: U.S. patent application Ser. No. ______ (RBSP 0101 PUSP), U.S. patent application Ser. No. ______ (RBSP 0106 PUSP), and U.S. patent application Ser. No. ______ (RBSP 0108 PUSP), all filed on ______, 2018. Each of the identified applications is incorporated by reference herein in its entirety.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A panoramic annular lens for projecting a spherical field of view onto a two-dimensional annular format, the panoramic annular lens comprising:
a body;
a first refractive surface configured to refract input light rays to obtain first refracted light rays;
a first reflective surface configured to reflect the first refracted light rays to obtain first reflected light rays;
a second reflective surface configured to reflect the first reflected light rays to obtain second reflected light rays; and
a second refractive surface configured to refract the second reflected light rays to obtain output light rays in the two-dimensional annular format, the second refractive surface externally concave.

2. The panoramic annular lens of claim 1, wherein the second refractive surface has a curvature between 0.01 and 0.05.

3. The panoramic annular lens of claim 1, wherein the second refractive surface has a conic constant of 0.

4. The panoramic annular lens of claim 1, wherein the first refractive surface is externally convex.

5. The panoramic annular lens of claim 1, wherein the second refractive surface is aspheric.

6. The panoramic annular lens of claim 1, wherein the first reflective surface has a curvature of −0.1 to −0.04.

7. The panoramic annular lens of claim 1, wherein the first reflective surface is internally concave.

8. A panoramic annular lens for projecting a spherical field of view onto a two-dimensional annular format, the panoramic annular lens comprising:
a body;
a first refractive surface configured to collect input light rays from a predetermined angular range measured from a plane intersecting the first refractive surface and to refract the input light rays to obtain first refracted light rays, the predetermined angular range is +35° to −28°;
a first reflective surface configured to reflect the first refracted light rays to obtain first reflected light rays;
a second reflective surface configured to reflect the first reflected light rays to obtain second reflected light rays; and
a second refractive surface configured to refract the second reflected light rays to obtain output light rays in the two-dimensional annular format.

9. The panoramic lens of claim 8, wherein the first refractive surface is externally convex.

10. The panoramic lens of claim 8, wherein the predetermined angular range is +32° to −28°.

11. The panoramic lens of claim 8, wherein the first refractive surface is aspheric.

12. The panoramic lens of claim 8, wherein the body and the surfaces are formed of a single block of transmissive material.

13. The panoramic lens of claim 12, wherein the transmissive material is polycarbonate, polystyrene, or glass.

14. The panoramic lens of claim 8, wherein the reflective surfaces are coated with a reflective coating.

15. An imaging system for recording images of an illuminated scene, the imaging system comprising:
a panoramic annular lens including:
a body;
a first refractive surface configured to collect input light rays from the illuminated scene and to refract the input light rays to obtain first refracted light rays;
a first reflective surface configured to reflect the first refracted light rays to obtain first reflected light rays;
a second reflective surface configured to reflect the first reflected light rays to obtain second reflected light rays;
a second refractive surface configured to refract the second reflected light rays to obtain output light rays, the first and second refractive surfaces and the first and second reflective surfaces coaxially aligned with each other along a PAL axis; and
an optical sensor offset the PAL axis and configured to collect the output light rays and to convert the output light rays into sensor signals or current.

16. The imaging system of claim 15, wherein the optical sensor includes microlens arrays, the PAL includes chief ray angles matched to ray angles of the microlens arrays.

17. The imaging system of claim 15, further comprising an aperture stop configured to adjust a cone angle of diverging rays within the output light rays, and the aperture stop situated between the PAL and the optical sensor.

18. The imaging system of claim 17, further comprising a filter configured to selectively transmit rays having predetermined optical properties within the output light rays, the filter situated between the aperture stop and the optical sensor.

19. The imaging system of claim 18, wherein the predetermined optical properties are wave length and polarity.

20. The imaging system of claim 18, wherein the filter is situated between the aperture stop and the optical sensor.
